(19) United States
(12) Patent Application Publication
(10) Pub. No.: US 2010/0296500 A1
(43) Pub. Date: Nov. 25, 2010

(54) MOBILE STATION AND METHOD FOR SCANNING A SERVICE SET IDENTIFIER

(75) Inventor: Cheng-Wen Tang, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/767,682

(22) Filed: Apr. 26, 2010

(30) Foreign Application Priority Data
May 21, 2009 (CN) 200910302505.2

(51) Int. Cl. H04W 4/00; H04W 76/00

(52) U.S. Cl. 370/338; 455/434

(57) ABSTRACT

A mobile station scans a wireless channel that an access point uses to communicate with a third-party mobile station, receives a management frame from the access point in the wireless channel, and determines that the access point utilizes a close service set identifier (SSID) according to the management frame. The mobile station further imitates one of the access point and the third-party mobile station to transmit a disconnection frame to the other one of the access point and the third-party mobile station, so as to disconnect a communication between the access point and the third-party mobile station. The mobile station further intercepts a reconnection frame transmitted between the access point and the third-party mobile station, and extracts the closed SSID of the access point from the reconnection frame.

### BACKGROUND

1. Technical Field

Embodiments of the present disclosure relate to wireless local area networks, and more particularly to a mobile station and a method for scanning a service set identifier (SSID) of the mobile station.

2. Description of Related Art

In a wireless local area network (WLAN), each access point (AP) in the WLAN has a service set identifier (SSID). When a mobile station requests to connect to the access point, the mobile station must show the SSID of the access point to the access point. If the mobile station shows a SSID different from the SSID of the access point, the access point will reject the connection request of the mobile station.

Usually, the access point broadcasts the SSID of the access point, so that the mobile station can scan the SSID of the access point. However, if the access point utilizes a closed SSID, it is very different for the mobile station to scan the closed SSID, so the mobile station must know the closed SSID in advance. If the mobile station knows the closed SSID in advance, the mobile station can connect to the access point via the closed SSID.

Therefore, it is a big challenge to scan the closed SSID of the access point in the WLAN when the mobile station does not know the closed SSID of the access point in advance.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a mobile station in accordance with the present disclosure; and

FIG. 2 is a flowchart of one embodiment of a method for scanning a service set identifier (SSID) in accordance with one embodiment of the present disclosure.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

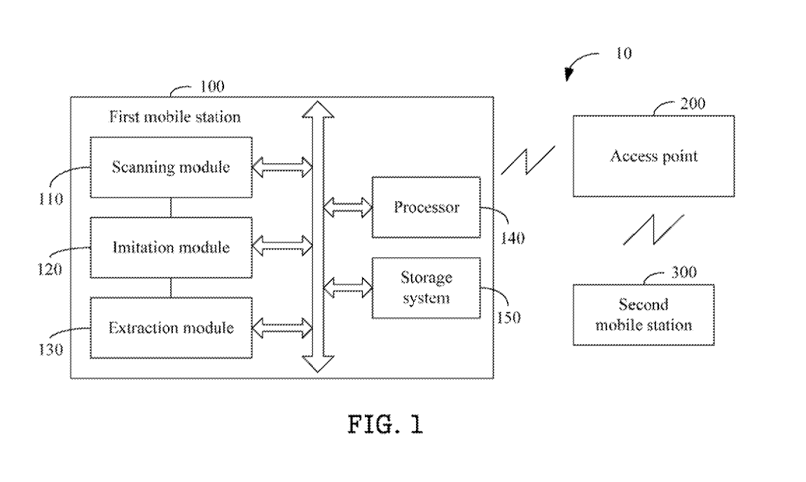

FIG. 1 is a schematic diagram of an application environment and functional modules of one embodiment of a first mobile station 100 in accordance with the present disclosure. In one embodiment, the first mobile station 100 is located in a wireless local area network (WLAN) 10 including an access point 200 and a second mobile station 300. The first mobile station 100 and the second mobile station 300 can be mobile phones, personal computers, notebook computers, or personal digital assistants (PDAs), for example.

In one embodiment, the access point 200 utilizes a closed service set identifier (SSID). The second mobile station 300 knows the closed SSID of the access point 200 in advance, and wirelessly communicates with the access point 200 according to the closed SSID of the access point 200. The first mobile station 100 does not know the closed SSID of the access point 200 in advance, and needs to scan the closed SSID of the access point 200 in order to communicate with the access point 200.

In one embodiment, the first mobile station 100 includes a scanning module 110, an imitation module 120, an extraction module 130, at least one processor 140, and a storage system 150. The modules 110, 120, 130 may comprise one or more computerized instructions which may be in the storage system 150 and executed by the at least one processor 140.

The scanning module 110 is operable to scan a wireless channel that the access point 200 uses to communicate with the second mobile station 300, and receives a management frame from the access point 200 in the wireless channel.

In one embodiment, the scanning module 110 actively scans the wireless channel, and the management frame may be a probe response frame. For example, the scanning module 110 broadcasts a probe request frame in the wireless channel to actively scan the wireless channel. The access point 200 will transmit a probe response frame to the first mobile station 100 when receiving the probe request frame in the wireless channel. Then, the scanning module 110 receives the probe response frame, namely the management frame, from the access point 200 in the wireless channel.

In another embodiment, the scanning module 110 may passively scan the wireless channel, and the management frame may be a beacon frame. For example, the access point 200 can continuously broadcasts a beacon frame in the wireless channel within a signal scope of the access point 200 according to the WLAN protocol. Then, the scanning module 110 can receive the beacon frame, namely the management frame, from the access point 200 in the wireless channel within the signal scope of the access point 200.

The scanning module 110 is further operable to determine that the access point 200 utilizes a closed SSID according to the management frame. In one embodiment, the management frame includes an SSID information element (IE) field operable to store SSID information of the access point 200. The SSID IE field may include null (e.g. /null/ ) or disordered codes, which indicates the access point 200 utilizes a closed SSID. Conversely, the SSID IE field may include ordered codes, which indicates the access point 200 does not utilize a closed SSID. In one example, the ordered codes may be SOLLSES. Thus, the scanning module 110 determines that the access point 200 utilizes the closed SSID according to the SSID IE field.

The imitation module 120 is operable to imitate one of the access point 200 and the second mobile station 300 to transmit a disconnection frame to the other one of the access point 200 and the second mobile station 300, in order to disconnect the communication between the access point 200 and the second mobile station 300. In one embodiment, the imitation module 120 can use a media access address (MAC) of the access point 200 to imitate the access point 200, or use a MAC address of the second mobile station 300 to imitate the second mobile station 300.

The extraction module 130 is operable to intercept a reconnection frame transmitted between the access point 200 and the second mobile station 300, and extract the closed SSID of the access point 200 from the reconnection frame.

In one example, the disconnection frame may be a de-authentication frame, and the reconnection frame may be a re-authentication request frame transmitted from the second mobile station 300 to the access point 200 or a re-authentication response frame transmitted from the access point 200 to the second mobile station 300. In detail, the first mobile station 100 imitates one of the access point 200 and the second mobile station 300 to transmit the de-authentication frame to the other one of the access point 200 and the second mobile station 300. Then, the communication between the access point 200 and the second mobile station 300 is disconnected. In order to continue the communication between the access point 200 and the second mobile station 300, the second mobile station 300 needs to re-authenticate the access point 200. That is, the second mobile station 300 needs to transmit a re-authentication request frame to the access point 200, and accordingly the access point 200 transmits a re-authentication response frame to the second mobile station 300. The re-authentication request frame and the re-authentication response frame must include the closed SSID of the access point 200. Thus, the extraction module 130 of the first mobile station 100 intercepts the re-authentication request frame and/or the re-authentication response frame, and extracts the closed SSID of the access point 200 from the re-authentication request frame and/or the re-authentication response frame.

In another example, the disconnection frame may be a de-association frame, and the reconnection frame may be a re-association request frame transmitted from the second mobile station 300 to the access point 200 or a re-association response frame transmitted from the access point 200 to the second mobile station 300. In detail, the first mobile station 100 imitates one of the access point 200 and the second mobile station 300 to transmit the de-association frame to the other one of the access point 200 and the second mobile station 300. Then, the communication between the access point 200 and the second mobile station 300 is disconnected. In order to continue the communication between the access point 200 and the second mobile station 300, the second mobile station 300 needs to re-associate with the access point 200. That is, the second mobile station 300 needs to transmit a re-association request frame to the access point 200, and accordingly the access point 200 transmits a re-association response frame to the second mobile station 300. The re-association request frame and the re-association response frame must include the closed SSID of the access point 200. Thus, the extraction module 130 of the first mobile station 100 intercepts the re-association request frame and/or the re-association response frame, and extracts the closed SSID of the access point 200 from the re-association request frame and/or the re-association response frame.

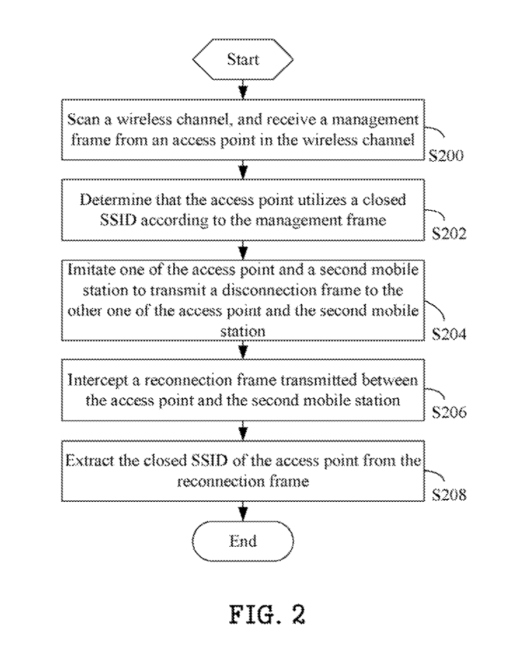

FIG. 2 is a flowchart of one embodiment of a method for scanning an SSID in accordance with the present disclosure. The method is executed by the functional modules of FIG. 1. Depending on the embodiment, additional blocks may be added, others deleted, and the ordering of blocks may be changed while remaining well within the scope of the disclosure.

In block S200, the scanning module 110 scans a wireless channel that the access point 200 uses to communicate with the second mobile station 300, and receives a management frame from the access point 200 in the wireless channel. In one embodiment, the scanning module 110 actively scans the wireless channel, and the management frame is a probe response frame.

In another embodiment, the scanning module 110 may passively scan the wireless channel, and the management frame is a beacon frame.

In block S202, the scanning module 110 determines that the access point 200 utilizes a closed SSID according to the management frame. In one embodiment, the management frame includes an SSID IE field. The SSID IE field includes null or disordered codes, which indicates the access point 200 utilizes a closed SSID. Thus, the scanning module 110 determines that the access point 200 utilizes the closed SSID according to the SSID IE field of the management frame.

In block S204, the imitation module 120 imitates one of the access point 200 and the second mobile station 300 to transmit a disconnection frame to the other one of the access point 200 and the second mobile station 300, in order to disconnect the communication between the access point 200 and the second mobile station 300.

In one embodiment, the second mobile station 300 and the access point 200 must transmit a reconnection frame between each other, in order to continue the communication between each other.

In block S206, the extraction module 130 intercepts the reconnection frame transmitted between the access point 200 and the second mobile station 300.

In block S208, the extraction module 130 extracts the closed SSID of the access point 200 from the reconnection frame.

In one embodiment, the disconnection frame may be a de-authentication frame, and the reconnection frame may be a re-authentication request frame transmitted from the second mobile station 300 to the access point 200 or a re-authentication response frame transmitted from the access point 200 to the second mobile station 300. Thus, the extraction module 130 extracts the closed SSID of the access point 200 from the re-authentication request frame and/or the re-authentication response frame.

In another embodiment, the disconnection frame may be a de-association frame, and the reconnection frame may be a re-association request frame transmitted from the second mobile station 300 to the access point 200 or a re-association response frame transmitted from the access point 200 to the second mobile station 300. Thus, the extraction module 130 extracts the closed SSID of the access point 200 from the re-association request frame and/or the re-association response frame.

Therefore, the first mobile station 100 successfully scans the closed SSID of the access point 200, and thereby the first mobile station 100 can communicate with the access point 200 by use of the closed SSID of the access point 200.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A mobile station, comprising:
one or more processors;
a storage system; and
one or more programs, wherein the one or more programs are stored in the storage system and executed by the one or more processors, the one or more programs comprising:
a scanning module operable to scan a wireless channel that an access point uses to communicate with a third-party mobile station, receive a management frame from the access point in the wireless channel, wherein the scanning module determines that the access point utilizes a close service set identifier (SSID) according to the management frame;
an imitation module operable to imitate one of the access point and the third-party mobile station to transmit a disconnection frame to the other one of the access point and the third-party mobile station, so as to disconnect a communication between the access point and the third-party mobile station; and
an extraction module operable to intercept a reconnection frame transmitted between the access point and the third-party mobile station, and extract the closed SSID of the access point from the reconnection frame.

2. The mobile station as claimed in claim 1, wherein the scanning module is operable to broadcast a probe request frame to the access point in the wireless channel to actively scan the wireless channel, so that the access point transmits a probe response frame back to the scanning module.

3. The mobile station as claimed in claim 2, wherein the management frame is the probe response frame.

4. The mobile station as claimed in claim 1, wherein the scanning module is operable to receive a beacon frame from the access point in the wireless channel to passively scan the wireless channel.

5. The mobile station as claimed in claim 4, wherein the management frame is the beacon frame.

6. The mobile station as claimed in claim 1, wherein the management frame comprises an SSID information element (IE) field operable to store SSID information of the access point.

7. The mobile station as claimed in claim 6, wherein the scanning module determines that the access point utilizes the closed SSID when the SSID IE field comprises codes selected from null codes and disordered codes.

8. The mobile station as claimed in claim 1, wherein the disconnection frame comprises a de-authentication frame, and the reconnection frame comprises a re-authentication request frame transmitted from the third-party mobile station to the access point and a re-authentication response frame transmitted from the access point to the third-party mobile station.

9. The mobile station as claimed in claim 1, wherein the disconnection frame comprises a de-association frame, and the reconnection frame comprises a re-association request frame transmitted from the third-party mobile station to the access point and a re-association response frame transmitted from the access point to the third-party mobile station.

10. A method for scanning a service set identifier (SSID) by a first mobile station, comprising:
scanning a wireless channel that an access point uses to communicate with a second mobile station by the first mobile station;
receiving a management frame from the access point in the wireless channel by the first mobile station;
determining that the access point utilizes a close SSID according to the management frame by the first mobile station;
imitating one of the access point and the second mobile station to transmit a disconnection frame from the first mobile station to the other one of the access point and the second mobile station, so as to disconnect a communication between the access point and the second mobile station, if the access point utilizes the close SSID;
intercepting a reconnection frame transmitted between the access point and the second mobile station by the first mobile station; and
extracting the closed SSID of the access point from the reconnection frame.

11. The method as claimed in claim 10, wherein the scanning step comprises broadcasting a probe request frame to the access point in the wireless channel to actively scan the wireless channel.

12. The method as claimed in claim 11, wherein the management frame is a probe response frame.

13. The method as claimed in claim 10, wherein the scanning block comprises receiving a beacon frame from the access point in the wireless channel to passively scan the wireless channel.

14. The method as claimed in claim 13, wherein the management frame is the beacon frame.

15. The method as claimed in claim 10, wherein the management frame comprises an SSID information element (IE) field operable to store SSID information of the access point.

16. The method as claimed in claim 15, wherein the determining block comprises determining that the access point utilizes the closed SSID when the SSID IE field comprises selective from null and disordered codes.

17. The method as claimed in claim 10, wherein the disconnection frame comprises a de-authentication frame, and the reconnection frame comprises a re-authentication request frame transmitted from the second mobile station to the access point and a re-authentication response frame transmitted from the access point to the second mobile station.

18. The method as claimed in claim 10, wherein the disconnection frame comprises a de-association frame, and the reconnection frame comprises a re-association request frame transmitted from the second mobile station to the access point and a re-association response frame transmitted from the access point to the second mobile station.
